(19) United States
(12) Patent Application Publication
(10) Pub. No.: US 2011/0086730 A1
(43) Pub. Date: Apr. 14, 2011

(54) BIODEGRADABLE SPORT OR GARDEN ARTICLES, AND APPARATUS FOR PRODUCING BIODEGRADABLE ARTICLES

(76) Inventor: David Witts, Boston (GB)

(21) Appl. No.: 12/996,819

(22) PCT Filed: Jun. 12, 2009
(86) PCT No.: PCT/GB09/50668

§ 371 Date: Dec. 8, 2010

(30) Foreign Application Priority Data
Jun. 12, 2008 (GB) 0810780.7

(51) Int. Cl. A63B 57/00; B29C 45/03; B29C 45/40

(52) U.S. Cl. 473/399; 425/556

(57) ABSTRACT

A biodegradable sport or garden article such as a golf tee is formed from a material comprising filler material, which can contain grass seeds, and a degradable binder therefor, so that discarded tees enhance the surface of the golf course, rather than littering it. Apparatus for manufacture of such articles comprises respective storage containers (8-11) for grass seed and a hardenable binder therefor, means (4-7) for controlling sequential discharge of the seed and the binder to a mould (16) for forming an article under a pressure sufficient to ensure compaction of the mixture within the mould, and means for discharging the tee from the mould. The apparatus may be in the form of a vending machine, manufacturing and dispensing golf tees in response to payment.

### FIELD OF THE INVENTION

This invention relates to a biodegradable sport or garden article, for example a golf tee and to a method of and apparatus for the manufacture of biodegradable sport or garden articles.

### BACKGROUND TO THE INVENTION

Conventional golf tees are formed of a moulded hard plastics material; in earlier times they have been formed of wood. Tees are frequently lost or abandoned on the golf course, and can give rise to problems with maintenance of the course—they are unsightly and can interfere with the operation of grass cutting equipment. Plastics materials may last for a very long time, and even wood and degradable plastics take a long time to degrade and disappear. There is a need, therefore, to manufacture golf tees and the like from materials which degrade rapidly and in a manner which will enhance the appearance of the teeing off area of the golf course.

Biodegradable golf tees of various descriptions have been proposed in a number of patent specifications. For example, U.S. Pat. No. 1,493,687, published in 1924, suggested the use of “a vegetable material . . . which disintegrates when left in the ground and may serve as a fertilizer”, shaped in a suitable mould. U.S. Pat. No. 1,645,001 discloses the use of grass seed and fertiliser in a gelatine binder to be moulded as a tee. More recently, U.S. Pat. No. 5,690,563 proposed moulding a tee from compressed rendered animal meal, with a corn starch adhesive sprayed on to the surface to add strength.

A problem with all these proposed golf tees is that they necessarily have a limited shelf-life, since if they are durable enough to remain usable after transport from the factory and storage, they are likely to take an unacceptably long time before breaking down when left on the golf course, for example. A further problem is that it may be desirable to offer different compositions of materials making up the biodegradable tee at different times of the year. For example, in the winter there is little point in incorporating grass seed, because it will not germinate at low temperatures, and different nutrients might need to be supplied at other times of the year in combination with seed.

### SUMMARY OF THE INVENTION

According to one aspect of the invention, a biodegradable sport or garden article formed from a filler material containing two or more components, and a hardenable degradable binder therefor, is characterised in that the concentration of at least one of the components of the filler material varies according to the location within the article.

Preferably, one of the components is viable seeds, more preferably grass seeds. Alternatively, or additionally, a component of the filler material is a plant nutrient or fertiliser to promote growth of the seeds when released by degradation of the binder, or simply to feed the existing grass in which or on which the article is abandoned.

The article may be a golf tee, and can be shaped in the form of a conventional tee having a spike for insertion into the ground, surmounted by a cup for locating the golf ball prior to its being struck by a golf club.

The binder is suitably a starch-based binder, for example formed of potato starch, which will retain the shape of the tee, for example, for a sufficient time to permit single use of the tee in the normal fashion, but which will break down in the presence of water, allowing the components to be dispersed on to or into the ground. Where grass seed is included, some will grow into grass plants to enhance the playing surface. This may be particularly advantageous in the teeing off area, where frequent damage to the grass turf may be caused by the action of golf clubs. Other suitable binders may be poly(vinyl alcohol), egg derivatives such as albumen, and cellulose, for example such as forms the basis of wallpaper adhesives. The binder may be hardenable by a chemical action and/or the action of heat at a temperature insufficient to affect the viability of the seeds, where these are incorporated. For example, the binder might be activated by the addition of a catalyst prior to mixing with the grass seeds. Ideally, the binder will be stable enough to produce a shelf-life of up to three months, but will begin to break down within 24 to 48 hours after use and exposure to moisture, for example. The binder will, of course, be selected to be non-toxic to wildlife and harmless to plant material.

Another component of the filler material may be a bulking agent, for example selected from waste paper, cellulose derivatives, clays and woodflour, and mixtures of any of these. The waste paper could be that resulting from the normal activities of a golf club, such as discarded score cards, publicity materials, newspapers and the like, shredded or otherwise reduced into small pieces.

The binder may be mixed with the filler material, or the hardened binder may form a shell containing the filler material. In the latter case, where seeds are to be incorporated into the article, these could be included in the binder shell so as to be released directly into contact with the soil.

In a preferred embodiment, the article is a golf tee which includes a spike for insertion into the soil, and the spike incorporates a layer of grass seed at a position along the length of the spike such that, when the binder breaks down, the seed is released into the soil, rather than simply falling on to the surface of the soil.

According to another aspect of the invention, apparatus for the manufacture of biodegradable sport or garden articles, comprises respective storage containers for filler components and a hardenable binder therefor, means for delivering the filler components and binder to a mould under a pressure sufficient to ensure compaction of the mixture within the mould, and means for discharging the article from the mould when the material is sufficiently firm, and is characterised by payment-receiving or -authorising means arranged to initiate operation of the apparatus in response to receipt of a payment or payment authorisation.

Preferably, the apparatus comprises a plurality of moulds, whereby a plurality of the articles can be moulded in a single operation of the apparatus. The articles may be discharged from the moulds and then subjected to a further curing or drying stage to harden the binder fully before delivery of the articles to the person using the apparatus.

The apparatus is under the control of a coin-release or other payment-receiving or authorising mechanism, whereby receipt of a payment initiates operation of the apparatus to produce a set of articles, for example golf tees. It will be understood that payment or authorisation may be in the form of a token or electronic card or key. The on-demand manufacturing apparatus enables the tees to be freshly manufactured when they are required, permitting the use of materials which will break down more quickly when abandoned on the golf course. Such tees might not be sufficiently stable to permit distribution and storage in the normal way. In addition, fresh seed is more likely to germinate and grow, and an on-demand type of apparatus might also permit the user to specify the components for the tee, or permit the operator of the golf course to vary components, for example grass variety or mix and additional or alternative additives such as fertilisers, according to the season or particular requirements of the course. The apparatus will also provide a source of additional revenue for the golf club, while reducing maintenance costs.

### BRIEF DESCRIPTION OF THE DRAWINGS

In the drawings, which illustrate an exemplary embodiment of the invention:

FIG. 1 is a diagram of a coin-release machine for manufacturing golf tees;

FIG. 2 is a view of a golf tee produced by the machine illustrated in FIG. 1; and

FIG. 3 is an enlarged view of a golf tee in accordance with one aspect of the invention.

### DETAILED DESCRIPTION OF THE ILLUSTRATED EMBODIMENT

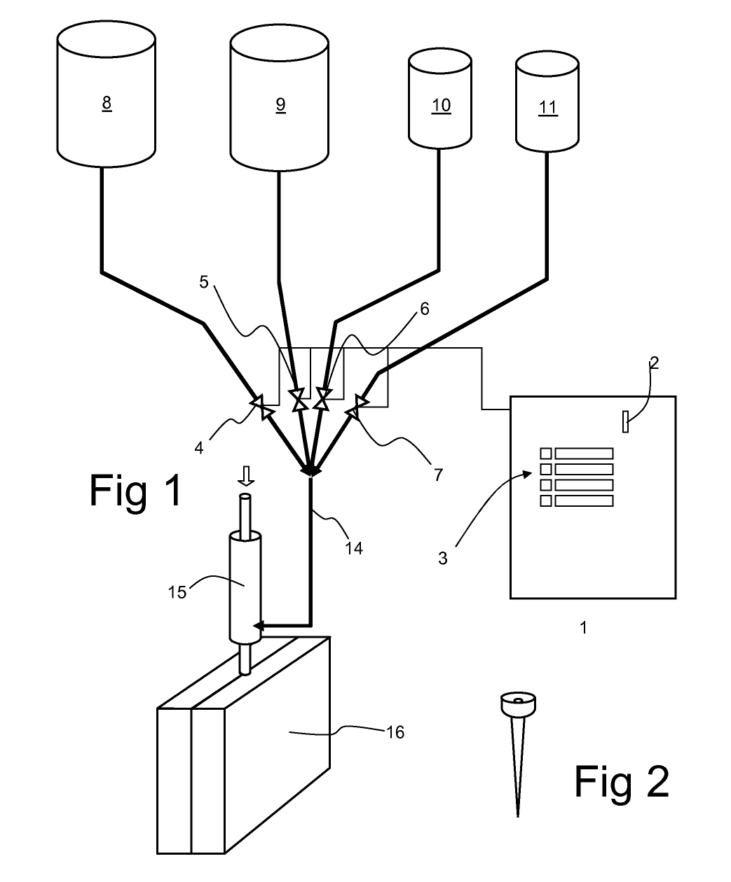

Referring to FIG. 1, one embodiment of the apparatus of the invention is an automated vending machine for producing golf tees on demand. The machine comprises a casing (not shown) carrying a control panel 1 on which are provided a coin slot 2 and selector buttons 3 for selecting the tee required, for example having different constituents, or of different shapes, or for selecting different quantities of tees. It will be appreciated that additionally, or alternatively, means may be provided for receiving payment by credit or debit card, prepaid token, or any other convenient method. Equally, other interface devices, such as a touch screen, may be used instead of push-buttons.

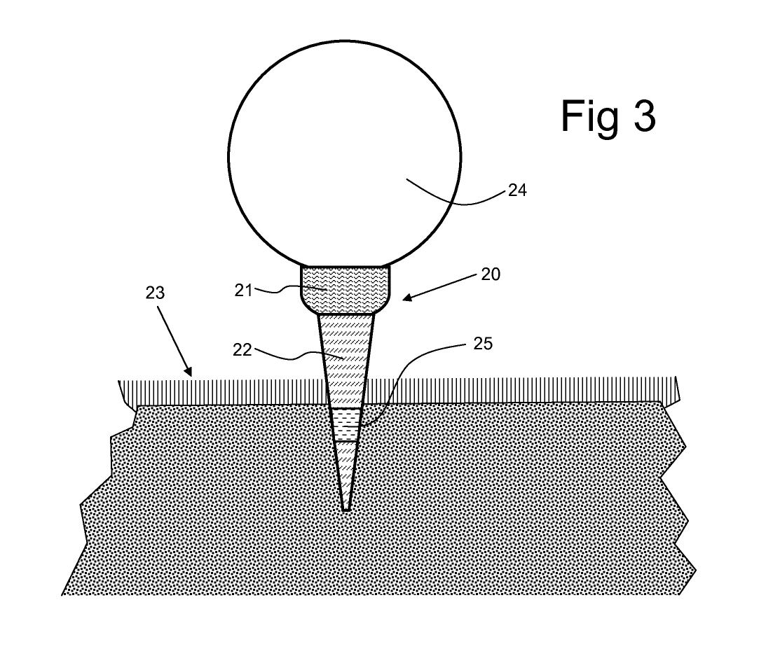

The control panel includes processing means controlling the sequence of operations of the machine when the transaction has been authorised. Firstly solenoid valves 4, 5, 6 and 7 release in a pre-determined time sequence pre-determined quantities of, respectively, grass seed, binder, fertiliser, and further additive such as a biodegradable dye to render the tee more easily visible in use, or a moss treatment agent, from storage hoppers 8, 9, 10 and 11. The sequenced components are fed through line 14 into a feed ram 15 having a suitable drive means, for example a screw driven by an electric motor (not shown), again controlled by the processing means, and arranged to force the mixture into a two-part mould 16. The time sequence enables different parts of the tee to be moulded, if desired, from different filler material, for example as hereinafter described with reference to FIG. 3.

The mould 16 is then opened to discharge the compacted moulded mixture, which can then be finally hardened by, for example, the application of a stream of warm air to dry the mixture. It will be appreciated that hardening may be achieved by different means, depending on the nature of the binder. The hardened tees are then discharged to a delivery point in the machine for removal by the user.

The hoppers can readily be filled with different components at different times of the year, for example to suit seasonal requirements in the maintenance of the golf course. Different varieties of grass seed may be introduced, and different types and strengths of fertiliser and other ingredients. A mixing stage could be incorporated, if required, to mix together certain of the components before their introduction into the mould.

FIG. 2 shows a typical tee in accordance with the invention. It will be understood, however, that different sizes and shapes of tee can be produced in accordance with the invention, and although reference is made in the specific description to a golf tee, it will be apparent that other similar articles may be manufactured in the same way, for example pitch repair markers or tools, golf shoe spikes, putt marks, or even disposable gardening tools.

FIG. 3 shows a tee inserted into a portion of turf on the golf course, and with a golf ball (shown diagrammatically only) placed on it. The tee 20 is of generally conventional shape, having a head portion 21 on a tapering spike 22 which is pushed into the turf 23 to hold the tee upright while it supports the ball 24. The tee is moulded from a mixture of filler material and binder, which is varied along the length of the tee. For example, the spike 22 may be generally formed of filler material containing an inert component, such as shredded or crumbed waste paper, and the binder, but with a layer 25 intermediate the ends thereof containing grass seeds, such that, when the tee degrades, for example in the presence of moisture, the seeds are deposited within the soil, ensuring that they have the best chance of germinating, rather than drying on the surface or being eaten by birds or mice, for example. The head 21 could be moulded from filler material containing a proportion of fertiliser which will be deposited on to the surface of the turf as the tee breaks down, feeding the grass at the surface and the seeds below.

It will be appreciated that different arrangements of layers may be achieved for different circumstances, for example to deal with seasonal requirements.

1. A biodegradable sport or garden article formed from a filler material containing two or more components, and a hardenable degradable binder therefor, characterised in that the concentration of at least one of the components of the filler material varies according to the location within the article.

2. An article according to claim 1, wherein one of the components is viable seeds.

3. An article according to claim 2, wherein the seeds are grass seeds.

4. An article according to claim 1, wherein a component of the filler material is a plant nutrient or fertiliser.

5. An article according to claim 1, wherein the binder is selected from poly(vinyl alcohol), starch, albumen, and cellulose.

6. An article according to claim 1, wherein a component of the filler material is a bulking agent.

7. An article according to claim 6, wherein the bulking agent is selected from the croup consisting of waste paper, cellulose derivatives, clays and woodflour, and mixtures of any of these.

8. An article according to claim 1, wherein the hardened binder forms a shell containing the filler material.

9. An article according to claim 1, wherein the binder is mixed with the filler material.

10. An article according to claim 1, which is a golf tee.

11. An article according to claim 10, wherein the tee includes a spike for insertion into the soil, and the spike incorporates a layer of grass seed at a position along the length of the spike such that, when the binder breaks down, the seed is released into the soil.

12. Apparatus for the manufacture of biodegradable sport or garden articles, comprising respective storage containers for filler components and a hardenable binder therefor, means for delivering the filler components and binder to a mould under a pressure sufficient to ensure compaction of the mixture within the mould, and means for discharging the article from the mould, characterised by payment-receiving or -authorising means arranged to initiate operation of the apparatus in response to receipt of a payment or payment authorisation.

13. Apparatus according to claim 12, comprising a plurality of moulds.

14. Apparatus according to claim 12, wherein the payment-receiving means is a coin-release mechanism.

15. Apparatus according to claim 12, wherein the payment-authorising means is a credit- or debit-card terminal.

16. Apparatus according to claim 12, wherein the mould is shaped to form a golf tee.

17. Apparatus according to claim 12, comprising control means programmed to deliver the filler components to the mould sequentially whereby to vary the concentration of at least one of the components of the filler material according to the location within the article.
